(19) United States
(12) Patent Application Publication
(10) Pub. No.: US 2010/0045555 A1
(43) Pub. Date: Feb. 25, 2010

(54) Array Antenna System Automatically Adjusting Space Between Arranged Antennas

(75) Inventors: Byung Hoon Ryou, Seoul (KR); Won Mo Sung, Gyeonggi-do (KR); Yun Bok Lee, Seoul (KR); Jeong Pyo Kim, Seoul (KR); Jun Woo Park, Seoul (KR); Jun Han Park, Seoul (KR); Myo Geun Yang, Incheon (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: E.M.W. ANTENNA CO., LTD, Geumcheon-gu, Seoul (KR)

(21) Appl. No.: 12/227,965

(22) PCT Filed: May 10, 2007
(86) PCT No.: PCT/KR2007/002287

§ 371 Date: Nov. 13, 2009

(30) Foreign Application Priority Data
Jun. 7, 2006 (KR) 10-2006-0050980

(51) Int. Cl. H01Q 3/02

(52) U.S. Cl. 343/757

(57) ABSTRACT

An array antenna system including: a base frame; a plurality of antenna elements which is arranged on the base frame; a driving unit which provides a driving power to each of the plurality of antenna elements when the plurality of antenna elements is moved or transformed on the base frame; a sensor unit which senses a change of a radio wave environment; and a control unit which transmits a driving signal to the driving unit according to a change of the radio wave environment, the change of the radio wave environment being sensed by the sensor unit.

### TECHNICAL FIELD

The present invention relates to an array antenna system automatically adjusting a space between arranged antennas, and more particularly, to an array antenna system which automatically changes a space and an arrangement form of antenna elements according to a change of a radio wave environment.

### BACKGROUND ART

In array antennas, many antenna elements are arranged and phases of excitation current of each antenna element are adjusted. Also, in array antennas, each antenna element is set at particular direction and phase, and thus main beams are formed. Currently, array antennas are applied to a variety of radio wave environments such as a radio frequency identification (RFID), and the like.

In such array antennas, the number of antenna elements, spaces between antenna elements, and arrangement forms are required to be designed for optimal performances depending on installation locations and environments.

However, in array antennas in a conventional art, performances such as spaces between antenna elements, beam radiation angles, and the like, are fixed to be suitable for particular applications. Accordingly, when array antennas in a conventional art are applied to various radio wave environments such as RFID, it is difficult to vary the number of antenna elements, spaces between antenna elements, and arrangement forms for optimal performances for each environment. Thus, optimal beam patterns for various radio wave environments may not be formed.

### DISCLOSURE OF INVENTION

### Technical Goals

The present invention provides an array antenna system which maintains an optimal receiving status by automatically adjusting a space between arranged antennas according to a change of a radio wave environment.

The present invention also provides an array antenna system which may vary a configuration and a form of the array antenna system depending on an installation location and environment.

### Technical Solutions

According to an aspect of the present invention, there is provided an array antenna system including: a base frame; a plurality of antenna elements which is arranged on the base frame; a driving unit which provides a driving power to each of the plurality of antenna elements when the plurality of antenna elements is moved or transformed on the base frame; a sensor unit which senses a change of a radio wave environment; and a control unit which transmits a driving signal to the driving unit according to the change of the radio wave environment, the change of the radio wave environment being sensed by the sensor unit.

Preferably, The sensor unit may include a received signal strength indicator (RSSI) circuit which detects a strength of a signal received by each of the plurality of antenna elements, and the control unit may transmit the driving signal to the driving unit according to the strength of the signal detected by the RSSI circuit.

The control unit may transmit, to the driving unit, one driving signal enabling a space between each of the plurality of antenna elements to be widened when the strength of the signal detected by the RSSI circuit is lower than a preset reference value, and may transmit, to the driving unit, a different driving signal enabling the space between each of the plurality of antenna elements to be narrowed when the strength of the signal detected by the RSSI circuit is higher than the preset reference value.

The base frame may be made of a conductive material capable of reflecting an electromagnetic wave.

Each of the plurality of antenna elements may include a radiator which resonates with an electromagnetic wave of a particular frequency and a conductive reflecting plate which is spaced apart from a back side of the radiator by a predetermined distance.

The transformation of each of the plurality of antenna elements may refer to a change of a space between the radiator and the reflecting plate.

The reflecting plate may be in a shape of a folded plate and the transformation of each of the plurality of antenna elements may refer to a change of an angle where the reflecting plate is folded.

The array antenna system according to an aspect of the present invention may further include a plurality of coupling members which couples the base frame and each of the plurality of antenna elements to be selectively separable from each other. Also, at least a guide slot may be provided in the base frame to enable each of the plurality of coupling members to be guided. The number of the guide slot may be the same as the number of antenna elements.

The guide slot may be radially positioned from a center of the base frame.

The plurality of antenna elements may be a circular polarized antenna, each of the plurality of antenna elements may have a same shape, the number of the plurality of antenna elements may be four, and an angle between each of the plurality of antenna elements and adjacent antenna element may be 90 degree.

Also, each of the plurality of antenna elements may be a circular polarized antenna, and shapes and arrangement directions of the plurality of antenna elements may be identical.

The base frame may include a center frame and a plurality of moving frames which is relatively movably coupled with the center frame. In this instance, each of the plurality of antenna elements may be provided to be movable relative to each of the plurality of moving frames, in an intersecting direction with respect to a movement direction of each of the plurality of moving frames.

The driving unit may include a stepping motor generating the driving power, a pinion gear coupled with an axis of the stepping motor, and a rack gear integrally formed with the each of the plurality of antenna elements to be engaged with the pinion gear.

The driving unit may include a stepping motor generating the driving power, and a rotating cam coupled with an axis of the stepping motor and provided between each of the plurality of antenna elements.

The driving unit may include a stepping motor generating the driving power, a ball screw coupled with an axis of the stepping motor, and a connecting member connected with the each of the plurality of antenna elements and provided to be movable according to the ball screw.

### BRIEF DESCRIPTION OF DRAWINGS

FIG. 1 is a perspective view illustrating an example of an array antenna system according to an embodiment of the present invention;

FIG. 2 is a cross-sectional view of an array antenna system which is cut based on an axis of I-I of FIG. 1;

FIGS. 3 and 4 are top views illustrating a translation of each antenna element included in an array antenna system according to an embodiment of the present invention;

FIGS. 5, 6, and 7 are side views illustrating various embodiments of a driving unit included in an array antenna system according to embodiments of the present invention; and

FIGS. 8 and 9 are perspective views illustrating an array antenna system according to another embodiment of the present invention.

### BEST MODE FOR CARRYING OUT THE INVENTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

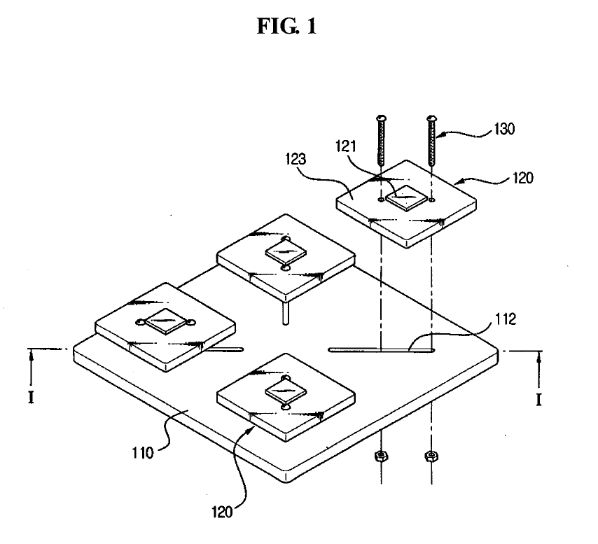

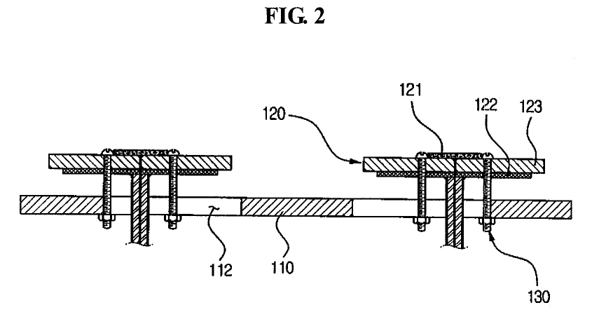

FIG. 1 is a perspective view illustrating an example of an array antenna system according to an embodiment of the present invention. FIG. 2 is a cross-sectional view of an array antenna system which is cut based on an axis of I-I of FIG. 1.

As illustrated in FIGS. 1 and 2, the array antenna system according to an embodiment of the present invention includes a base frame 110, a plurality of antenna elements 120, a driving unit which is not illustrated, a sensor unit which is not illustrated, and a control unit which is not illustrated. The plurality of antenna elements 120 is arranged on the base frame 110. The driving unit provides a driving power to each of the plurality of antenna elements 120 when the plurality of antenna elements 120 is moved or transformed on the base frame 110. The sensor unit includes a received signal strength indicator (RSSI) circuit which detects a strength of a signal received by each of the plurality of antenna elements 120. The control unit transmits a driving signal to the driving unit according to the strength of the signal detected by the RSSI circuit.

The base frame 110 may be formed in various shapes, and supports each antenna element 120. The base frame 110 may be made of a conductive material capable of reflecting an electromagnetic wave radiated towards the base frame 110 from the plurality of antenna elements 120. In this instance, a beam pattern by each of the plurality of antenna elements 120 may vary depending on an area of the base frame 110.

The plurality of antenna elements 120 is provided to be movable on the base frame 110. The plurality of antenna elements 120 may receive and transmit a linearly polarized wave or a circularly polarized wave. Also, the plurality of antenna elements 120 may be embodied as a monopole antenna, a dipole antenna, a planar inverted-F antenna, a planar inverted-L antenna, or a microstrip patch antenna. The number of the plurality of antenna elements 120 may vary according to a required condition such as a radio wave environment, and the like.

As illustrated in FIG. 2, the plurality of antenna elements 120 may include a radiator 121, a ground layer 122, and a dielectric layer 123. The radiator 121 is made of the conductive material. The ground layer 122 is spaced apart from the radiator 121 by a predetermined distance in a thickness direction of the radiator 121. The dielectric layer 123 is made of a dielectric material such as a ceramic or a resin, and fills a space between the radiator 121 and the ground layer 122. In this instance, a feeding cable of each of the plurality of antenna elements 120 may be made of a flexible material in order to be smoothly folded or bent when the plurality of antenna elements 120 moves. The feeding cable of each of the plurality of antenna elements 120 may be preferably integrated in a single direction to easily install a line. An integrated circuit may be an electric power distribution circuit or a switching circuit.

A plurality of coupling members 130 may couple the base frame 110 and each of the plurality of antenna elements 120 to be selectively separable from each other. Conventional bolts and nuts, and the like, may be used as the plurality of coupling members 130. The base frame 110 and each of the plurality of antenna elements 120 may be easily separated from each other by separating the plurality of coupling members 130. The above-described configuration may enable the base frame 110 to be replaced with a different base frame which is made of the conductive material and has a different size depending on a required condition. Accordingly, the beam pattern may be optimized according to a variety of situations and the radio wave environment, e.g. when a big object is recognized in a large area or when a small object is recognized in a small area.

A guide slot 112 may be provided in the base frame 110 to enable each of the plurality of coupling members 130 to pass and to be guided. Accordingly, each of the plurality of antenna elements 120 may move horizontally with ease. A number of guide slots 112 may be the same as a number of antenna elements 120.

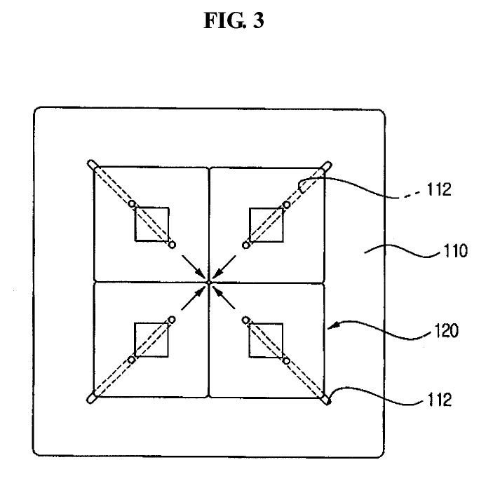

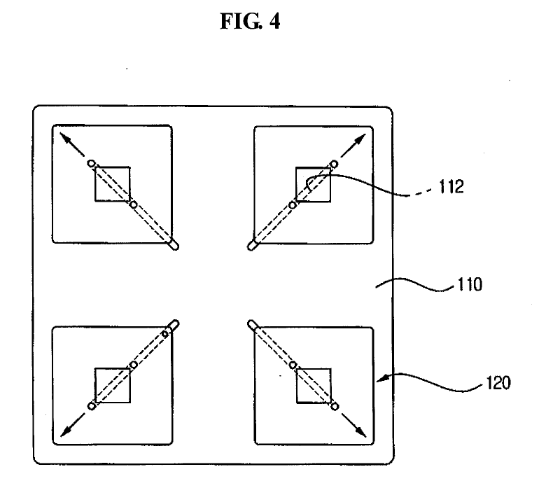

The guide slot 112 may be formed in a straight line in any one of a horizontal, a vertical, and another direction of the base frame 110, or may be formed in a curved line. Also, the guide slot 112 may be formed in a shape of “L”. FIGS. 3 and 4 are top views illustrating a translation of each antenna element included in an array antenna system according to an embodiment of the present invention. As illustrated in FIGS. 3 and 4, the guide slot 112 is radially positioned from a center of a base frame 110 so that each of the plurality of antenna elements 120 may be arranged to have equal spacing. Specifically, the guide slot 112 is diagonally formed in a straight line. Accordingly, when each of the plurality of antenna elements 120 moves towards the center of the base frame 110 or in an opposite direction, away from the center of the base frame 110 in a straight direction, and the straight movement of each of the plurality of antenna elements 120 may be performed by a single driving signal. Also, spaces between the plurality of antenna elements 120 may remain identical while the space between each of the plurality of antenna elements 120 is changed according to the driving signal.

A movement of each of the plurality of antenna elements 120 on the base frame 110 may be a translation along a curved line (including a straight line) on a plane of the base frame 110, a translation along a straight line perpendicular to the plane of the base frame 110, a rotation based on an axis parallel to the plane of the base frame 110, or a rotation based on an axis perpendicular to the plane of the base frame 110. Also, the movement of each of the plurality of antenna elements 120 on the base frame 110 may correspond to a combination of at least two of the above-described translations. The translation of each of the plurality of antenna elements 120 along the curved line on the plane of the base frame 110 changes the space between each of the plurality of antenna elements 120, and thereby changes a beam width of an entire array antenna. The translation of each of the plurality of antenna elements 120 along the straight line perpendicular to the plane of the base frame 110 changes a space between the plurality of antenna elements 120 and the base frame 110, capable of being performed as a reflecting plate, and thereby may change a beam width of an individual antenna element 120. The rotation of each of the plurality of antenna elements 120 based on the axis parallel to the plane of the base frame 110 changes a beam direction of each of the plurality of antenna elements 120. The rotation based on the axis perpendicular to the plane of the base frame 110 will be described later in the present specification.

The movement of each of the plurality of antenna elements 120 on the base frame 110 is automatically performed by a driving unit, a sensor unit, and a control unit. Specifically, an RSSI circuit included in the sensor unit detects a strength of a signal received by each of the plurality of antenna elements 120. The control unit transmits a driving signal to the driving unit according to the strength of the signal detected by the RSSI circuit. The driving unit provides a driving power to each of the plurality of antenna elements 120 when the plurality of antenna elements 120 moves on the base frame 110 according to the driving signal received from the control unit.

According to an embodiment of the present invention, the driving signal of the control unit may be generated and transmitted as below. when the strength of the signal detected by the RSSI circuit is lower than a preset reference value, the control unit transmits one driving signal to the driving unit. The driving signal enables a space between each of the plurality of antenna elements 120 to be widened. Accordingly, a recognition rate of the received signal may increase by narrowing the beam width of the entire array antenna. Also, when the strength of the signal detected by the RSSI circuit is higher than the preset reference value, the control unit transmits a different driving signal to the driving unit since the recognition rate of the received signal is sufficiently high. The different driving signal enables the space between each of the plurality of antenna elements 120 to be narrowed. Accordingly, a recognition range of the received signal may extend by extending the beam width of the entire array antenna.

The sensor unit may include another circuit device different from the RSSI circuit to sense a change of the radio wave environment, and thus the movement of each of the plurality of antenna elements 120 on the base frame 110 may be controlled so that the array antenna system maintains an optimal receiving status.

Also, as illustrated in FIGS. 3 and 4, a number of the plurality of antenna elements 120 may be four. Each of the plurality of antenna elements 120 is a circular polarized antenna, and may have a same shape. When an angle between each of the plurality of antenna elements 120 and adjacent antenna element 120 is 90 degrees, a phase of a circularly polarized wave received by each of the plurality of antenna elements 120 has a difference of 90 degrees from a phase of a circularly polarized wave received by the adjacent antenna elements 120. In this case, an effect that the entire array antenna simultaneously scans all directions is generated, and thereby may increase a recognition rate of a signal received from a large area. Conversely, when an arrangement direction of each of the plurality of antenna elements 120 is identical, the phase of circularly polarized wave received by each of the plurality of antenna elements 120 is identical. Accordingly, a gain of the entire array antenna is improved, which is suitable for a case when a signal received from a small area is recognized. Each of the plurality of antenna elements 120 rotates based on the axis perpendicular to the plane of the base frame 110 according to the radio wave environment, and thus the arrangement direction changes as described above. Accordingly, the array antenna system may adapt to the change of radio wave environment.

The array antenna system according to an embodiment of the present invention actively senses the change of radio wave environment, e.g. when an RFID tag is gathered in a small area or when the RFID tag is spread in a large area, and changes the space between each of the plurality of antenna elements 120. Accordingly, the optimal receiving status may be maintained.

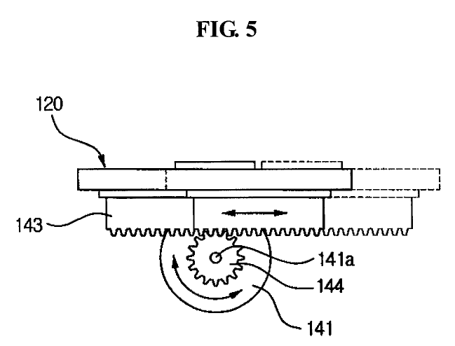

FIGS. 5, 6, and 7 are side views illustrating various embodiments of a driving unit included in an array antenna system according to embodiments of the present invention.

As an example, as illustrated in FIG. 5, the driving unit may include a stepping motor 141, a pinion gear 144, and a rack gear 143. The stepping motor 141 generates a driving power. The pinion gear 144 is coupled with an axis 141a of the stepping motor 141, and integrally rotates. The rack gear 143 is integrally formed with each of the plurality of antenna elements 120 to be engaged with the pinion gear 144. Accordingly, each of the plurality of antenna elements 120 receives the driving power of the stepping motor 141 via the pinion gear 144 and the rack gear 143, and thereby may move in a straight line.

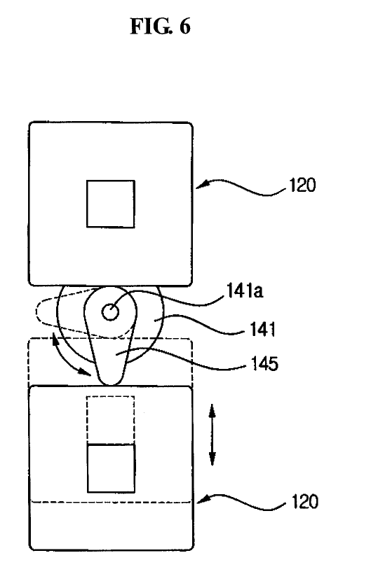

As another example, as illustrated in FIG. 6, the driving unit may include a stepping motor 141 and a rotating cam 145. The stepping motor 141 generates a driving power. The rotating cam 145 is coupled with an axis 141a of the stepping motor 141 and is provided between each of the plurality of antenna elements 120. The rotating cam 145 is formed to have a radius of different lengths based on a center of rotation. Also, the rotating cam 145 is provided to be able to make contact with the plurality of antenna elements 120. Each of the plurality of antenna elements 120 receives the driving power of the stepping motor 141 via the rotating cam 145, and thereby may move in a straight line. Above-described configuration is suitable for a case when a required displacement range of each of the plurality of antenna elements 120 according to a change of a radio wave environment is required to be relatively small.

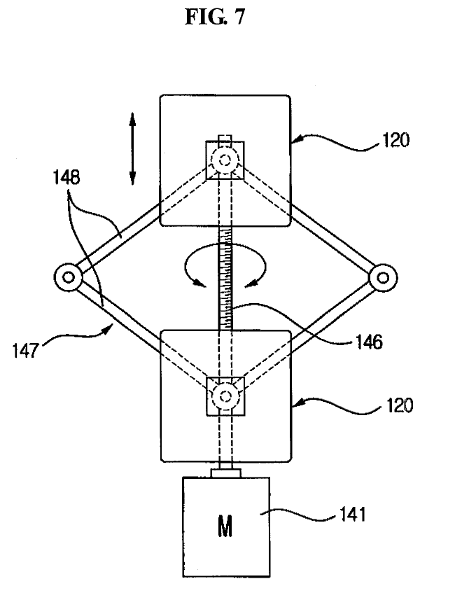

As still another example, as illustrated in FIG. 7, the driving unit may include a stepping motor (M) 141, a ball screw 146, and a connecting member 147. The stepping motor 141 generates a driving power. The ball screw 146 is coupled with an axis 141a of the stepping motor 141 and integrally rotates. The connecting member 147 is connected with each of the plurality of antenna elements 120 and provided to be movable according to the ball screw 146. The connecting member 147 may include a plurality of link members 148 connected to be rotatable relative to each other. Alternatively, the connecting member 147 may be formed to connect the ball screw 146 and each of the plurality of antenna elements 120. Accordingly, each of the plurality of antenna elements 120 receives the driving power of the stepping motor 141 via the connecting member 147, and thereby may move in a straight line.

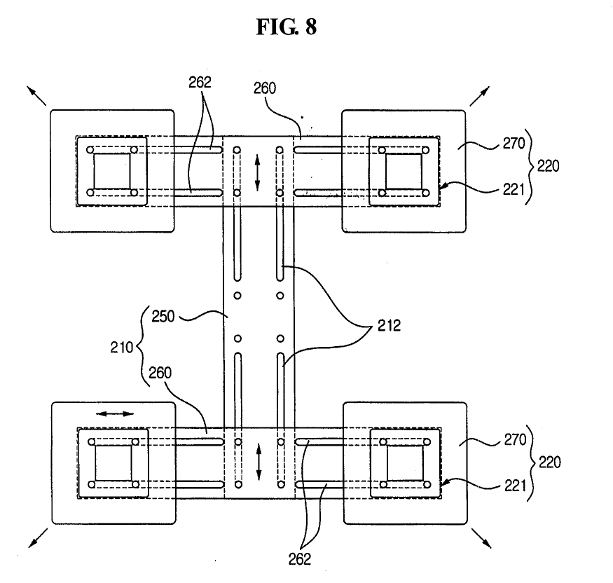

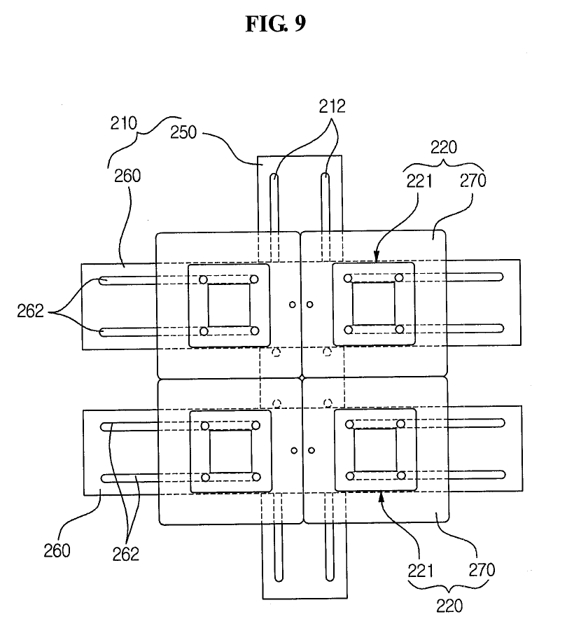

FIGS. 8 and 9 are perspective views illustrating an array antenna system according to another embodiment of the present invention. Also, in FIGS. 8 and 9, an identical or a corresponding reference number is provided with respect to an identical or a similar portion to a configuration described above. A detailed description of identical or similar portions previously described in the above is omitted.

As illustrated in FIGS. 8 and 9, the array antenna system according to another embodiment of the present invention includes a base frame 210 and a plurality of antenna elements 220 arranged on the base frame 210. The base frame 210 includes a center frame 250 and a plurality of moving frames 260. Each of the plurality of moving frames 260 is relatively and movably coupled with the center frame 250. Each of the plurality of antenna elements 220 is provided to be movable relative to each of the plurality of moving frames 260, in an intersecting direction with respect to a movement direction of each of the plurality of moving frames 260.

Each of the plurality of antenna elements 220 includes a radiator 221 which resonates with an electromagnetic wave of a particular frequency, and a reflecting plate 270 which is spaced apart from a back side of the radiator 221 by a predetermined distance. The reflecting plate 270 is made of a conductive material, and reflects the electromagnetic wave radiated from the back side of the radiator 221. Accordingly, a directivity of each of the plurality of antenna elements 220 may be improved by the reflecting plate 270. Also, a beam width of each of the plurality of antenna elements 220 may change by changing a size of the reflecting plate 270.

Generally, a flat reflecting plate is used as the reflecting plate 270, as illustrated in FIGS. 8 and 9. However, the reflecting plate 270 may be in a shape of a folded plate for an improvement of the directivity of each of the plurality of antenna elements 220 or a particular-shaped beam width formation. In this case, a driving unit, not illustrated, may provide a driving power to the reflecting plate 270 of the folded shape when an angle where the reflecting plate 270 is folded changes. A control unit, not illustrated, may transmit a driving signal to the driving unit according to a change of a radio wave environment. The change of the radio wave environment is sensed by a sensor unit which is not illustrated, and the driving signal, with respect to the change of the angle where the reflecting plate 270 is folded, is transmitted. Specifically, the angle where the reflecting plate 270 of each of the plurality of antenna elements 220 is folded automatically changes according to the change of the radio wave environment, and thus a beam width and a directivity suitable for the radio wave environment may be formed. A change of an angle where a reflecting plate is folded may be made by a hinge or another proposed method. The change of the angle where the reflecting plate of the folded shape is folded may be an example of a transformation of each of the plurality of antenna elements. Also, another transformation of each of the plurality of antenna elements may be available to easily adapt to the radio wave environment. A change of a space between the radiator 221 and the reflecting plate 270 may be included in the transformation of each of the plurality of antenna elements 220 to change a beam pattern of each of the plurality of antenna elements 220.

Each of the plurality of moving frames 260 and each of the plurality of antenna elements 220 may be coupled to be selectively separable via a plurality of coupling members 230. Conventional bolts and nuts, and the like, may be used as the plurality of coupling members 230. Also, the center frame 250 and each of the plurality of moving frames 260 may be coupled to be selectively separable via the plurality of coupling members 230.

Also, a plurality of guide slots 212 and 262 is provided at both ends of the center frame 250 and each of the plurality of moving frames 260 in a lengthwise direction to enable each of the plurality of coupling members 230 to pass and to be guided.

Accordingly, each of the plurality of moving frames 260 may slidably move along a lengthwise direction of the center frame 250. Each of the plurality of antenna elements 220 may slidably move along a widthwise direction of the center frame 250. The driving unit provides the driving power to each of the plurality of moving frames 260 when each of the plurality of moving frames 260 moves, and thereby may indirectly provide the driving power to each of the plurality of antenna elements 220 when each of the plurality of antenna elements 220 moves.

Also, the center frame 250 and each of the plurality of moving frames 260 may be formed in a same shape. A configuration of the array antenna system may be variously embodied according to an installation place and environment by standardizing the center frame 250, each of the plurality of moving frames 260, each of the plurality of antenna elements 220, and the plurality of coupling members 230.

In another embodiment of the present invention described above, although it is described that the center frame 250 and each of the plurality of moving frames 260 are connected in an approximate shape of “H” as an example, an arrangement of each of the center frame 250 and each of the plurality of moving frames 260 may vary according to a required condition, and the present invention is not limited to the present embodiment. As an example, the configuration described above may be three-dimensionally embodied in a gate form in a “U” shape. The gate form refers to a configuration where each of the plurality of antenna elements 220 is positioned at a left and right side and an upper side. Also, a feeding circuit of the array antenna system three-dimensionally structured above the array antenna system enables each of the plurality of antenna elements 220 to be successively operated using a switching circuit, and the like. Accordingly, an interference by each of the plurality of antenna elements 220 may be prevented.

The array antenna system according to the present embodiment actively senses a change of the radio wave environment, transforms a shape of antenna element, or changes a space between each antenna element, and thus an optimal receiving status is maintained. Also, the antenna element may two-dimensionally move on a base frame with a simple configuration including a center frame, a moving frame, and a straight guide slot.

Also, the array antenna system according to the present invention may be used as a test bench before installing a system, enabling to find an optimal arrangement form of a mass-producing antenna using several antennas having different properties.

According to the present invention, an array antenna system maintains an optimal receiving status by automatically adjusting a space between arranged antennas according to a change of a radio wave environment.

Also, according to the present invention, an array antenna system may vary a configuration of the array antenna system depending on an installation place and environment, and may be three-dimensionally structured.

1. An array antenna system comprising:
a base frame;
a plurality of antenna elements which is arranged on the base frame;
a driving unit which provides a driving power to each of the plurality of antenna elements when the plurality of antenna elements is moved or transformed on the base frame;
a sensor unit which senses a change of a radio wave environment; and
a control unit which transmits a driving signal to the driving unit according to the change of the radio wave environment, the change of the radio wave environment being sensed by the sensor unit.

2. The array antenna system of claim 1, wherein the sensor unit comprises a received signal strength indicator (RSSI) circuit which detects a strength of a signal received by each of the plurality of antenna elements, and the control unit transmits the driving signal to the driving unit according to the strength of the signal detected by the RSSI circuit.

3. The array antenna system of claim 2, wherein the control unit transmits, to the driving unit, one driving signal enabling a space between each of the plurality of antenna elements to be widened when the strength of the signal detected by the RSSI circuit is lower than a preset reference value, and transmits, to the driving unit, a different driving signal enabling the space between each of the plurality of antenna elements to be narrowed when the strength of the signal detected by the RSSI circuit is higher than the preset reference value.

4. The array antenna system of claim 1, wherein the base frame is made of a conductive material capable of reflecting an electromagnetic wave.

5. The array antenna system of claim 1, wherein each of the plurality of antenna elements comprises a radiator which resonates with an electromagnetic wave of a particular frequency and a conductive reflecting plate which is spaced apart from a back side of the radiator by a predetermined distance.

6. The array antenna system of claim 5, wherein the transformation of each of the plurality of antenna elements refers to a change of a space between the radiator and the reflecting plate.

7. The array antenna system of claim 5, wherein the reflecting plate is in a shape of a folded plate and the transformation of each of the plurality of antenna elements refers to a change of an angle where the reflecting plate is folded.

8. The array antenna system of claim 1, further comprising:
a plurality of coupling members which couples the base frame and each of the plurality of antenna elements to be selectively separable from each other,
wherein at least a guide slot are provided in the base frame to enable each of the plurality of coupling members to be guided, the number of guide slot being the same as the number of the antenna elements.

9. The array antenna system of claim 8, wherein the guide slot is radially positioned from a center of the base frame.

10. The array antenna system of claim 1 or 9, wherein the plurality of antenna elements is a circular polarized antenna, each of the plurality of antenna elements has a same shape, the number of the plurality of antenna elements is four, and an angle between each of the plurality of antenna elements and adjacent antenna element is 90 degree.

11. The array antenna system of claim 1, wherein each of the plurality of antenna elements is a circular polarized antenna, and shapes and arrangement directions of the plurality of antenna elements are identical.

12. The array antenna system of claim 1, wherein the base frame comprises a center frame and a plurality of moving frames which is relatively movably coupled with the center frame, and each of the plurality of antenna elements is provided to be movable relative to each of the plurality of moving frames, in an intersecting direction with respect to a movement direction of each of the plurality of moving frames.

13. The array antenna system of claim 1, wherein the driving unit comprises a stepping motor generating the driving power, a pinion gear coupled with an axis of the stepping motor, and a rack gear integrally formed with each of the plurality of antenna elements to be engaged with the pinion gear.

14. The array antenna system of claim 1, wherein the driving unit comprises a stepping motor generating the driving power, and a rotating cam coupled with an axis of the stepping motor and provided between each of the plurality of antenna elements.

15. The array antenna system of claim 1, wherein the driving unit comprises a stepping motor generating the driving power, a ball screw coupled with an axis of the stepping motor, and a connecting member connected with each of the plurality of antenna elements and provided to be movable according to the ball screw.
